(19) United States
(12) Patent Application Publication
(10) Pub. No.: US 2017/0004472 A1
(43) Pub. Date: Jan. 5, 2017

(54) METHOD FOR PROCESSING TRANSACTIONS AT A VENDING KIOSK

(71) Applicant: Pantry Retail, Inc., San Francisco, CA (US)

(72) Inventors: Artem Tkachenko, San Francisco, CA (US); Christopher Alika Ah New, San Juan Capistrano, CA (US); Zhongning Chen, San Francisco, CA (US); Alex Yancher, San Francisco, CA (US)

(21) Appl. No.: 15/148,314

(22) Filed: May 6, 2016

Related U.S. Application Data
(60) Provisional application No. 62/157,611, filed on May 6, 2015.

(51) Int. Cl. G06Q 20/18; G06K 7/14; G06K 19/077; G06K 19/06

(52) U.S. Cl. CPC G06Q 20/18; G06K 19/06037; G06K 7/1417; G06K 19/0776

(57) ABSTRACT

One variation of a method for processing transactions at a vending kiosk includes: at a first time, capturing a pre-transaction image of a shelf arranged within the kiosk with an optical sensor; in response to receiving payment information from a customer, unlocking a door of the kiosk; at a second time succeeding the first time, capturing a post-transaction image of the shelf with the optical sensor in response to closure of the door; detecting a difference between the pre-transaction image and the post-transaction image; based on the difference, flagging a portion of the pre-transaction image for review by a remote human operator; and, in response to identification of a product type corresponding to the difference by the remote human operator, billing the customer for a cost of the product type according to the payment information.

### CROSS-REFERENCE TO RELATED APPLICATIONS

This Application claims the benefit of U.S. Provisional Application No. 62/157,611, filed on 6 May 2015, which is incorporated in its entirety by this reference.

This Application is related to U.S. patent application Ser. No. 14/201,369, filed on 7 Mar. 2014, and to U.S. patent application Ser. No. 14/209,688, filed on 13 Mar. 2014, which are incorporated in their entireties by this reference.

### TECHNICAL FIELD

This invention relates generally to the field of vending kiosks and more specifically to a new and useful method for processing transactions at a vending kiosk.

### BRIEF DESCRIPTION OF THE FIGURES

FIG. 1 is a flowchart representation of a method.

### DESCRIPTION OF THE EMBODIMENTS

The following description of the embodiments of the invention is not intended to limit the invention to these embodiments but rather to enable a person skilled in the art to make and use this invention.

### 1. Method

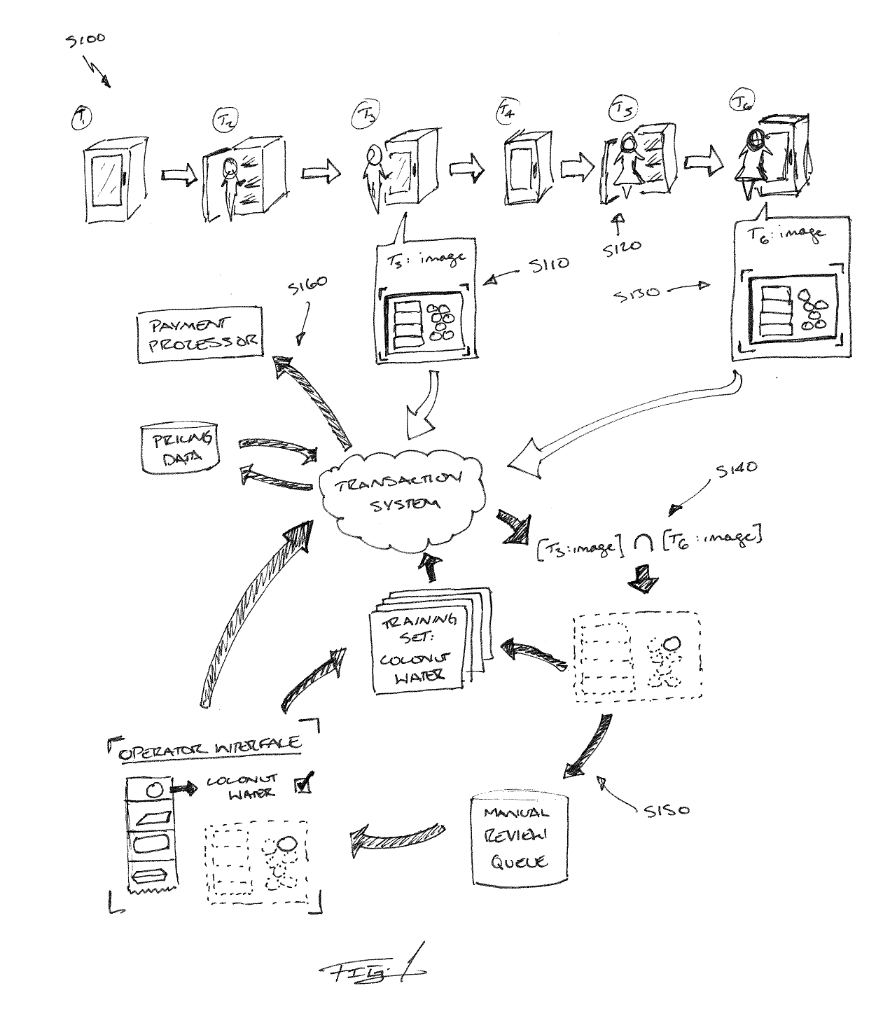

As shown in FIG. 1, a method S100 for processing transactions at a vending kiosk includes: at a first time, capturing a pre-transaction image of a shelf arranged within the kiosk with an optical sensor in Block S110; in response to receiving payment information from a customer, unlocking a door of the kiosk in Block S120; at a second time succeeding the first time, capturing a post-transaction image of the shelf with the optical sensor in response to closure of the door in Block S130; detecting a difference between the pre-transaction image and the post-transaction image in Block S140; based on the difference, flagging a portion of the pre-transaction image for review by a remote human operator in Block S150; and in response to identification of a product type corresponding to the difference by the remote human operator, billing the customer for a cost of the product type according to the payment information in Block S160.

### 2. Applications

Generally, the method S100 can be executed in conjunction with a vending kiosk—such as described in U.S. patent application Ser. Nos. 14/201,369 and 14/209,688—to retroactively identify units of products removed from the kiosk during transactions occurring at the kiosk over time and to retroactively bill customers according to the products each removed from the kiosk during a corresponding transaction. For example, the method S100 can collect an image of a open shelf of a kiosk substantially immediately prior to a transaction at the kiosk (a “pre-transaction image”), collect an image of the open shelf substantially immediately after the transaction at the kiosk (a “post-transaction image”), compare the pre- and post-transaction images to detect changes possibly indicative of removal of a product from the open shelf during the transaction, flag the pre- and/or post-transaction images for manual review by a remote human operator, and bill a customer who provided payment information for the transaction according to a cost of one or more products thus identified by the remote human operator as removed from the open shelf during the transaction. A remote transaction system (e.g., a remote server, a computer network) and/or a computer installed in the kiosk can therefore execute Blocks of the method S100 to process digital images and to (selectively) distribute images to one or more remote human operators for manual identification of specific products removed from the kiosk during various transactions over time. For example, the transaction system can distribute the same images for one transaction to two remote human operators, bill a customer according to products mutually identified by the two remote human operators, and then prompt a third human operator to identify removed product pending disagreement between products identified by the two remote human operators.

The transaction system can also store and track product types identified by remote human operators with corresponding pre- and/or post-transaction images to build a training set of template images for products stocked in the kiosk over time. Thus, as a number of transaction involving a particular product type at a kiosk (or within a network of kiosks) grows, the transaction system can implement computer vision techniques, according to the method S100, to automatically identify products removed from the kiosk by comparing pre- and/or post-transaction images to template images in the training set. For example, the transaction system can default to comparing pre- and/or post-transaction images (or a difference between the pre- and post-transaction images, or “target image,” as shown in FIG. 1) for each transaction at the kiosk, and the transaction can pass select transaction data to a remote human operator for manual review if a calculated confidence in identification of a product in a target image is less than a threshold confidence.

Blocks of the method S100 can be executed remotely by a transaction system hosted on a computer network and in communication with the kiosk and/or with a network of kiosks. Additionally or alternatively, Blocks of the method S100 can be executed locally by a kiosk. The transaction system can also serve pre- and/or post transaction images (or target images) and other transaction-related data—for transactions occurring at one or more kiosks—to an instance of an operator interface accessed by a remote human operator; the operator can thus review transaction data and submit identifications of products removed from kiosks through the operator interface. The transaction system can retrieve product identification from the remote human operator through an instance of the operator interface and then: interface with the corresponding kiosk or related database to update an inventory list for the kiosk; notify a supplier to restock the kiosk; interface with a payment system to bill a corresponding customer; and/or transmit an electronic receipt for the transaction to the customer.

### 3. Images

Block S110 of the method S100 recites, at a first time, capturing a pre-transaction image of a shelf arranged within the kiosk with an optical sensor; Block S120 of the method S100 recites, in response to receiving payment information from a customer, unlocking a door of the kiosk; and Block S130 of the method S100 recites, at a second time succeeding the first time, capturing a post-transaction image of the shelf with the optical sensor in response to closure of the door. Generally, a vending kiosk can execute Blocks S110, S120, and S130 of the method S100 to capture a pre-transaction image of one or more shelves within the kiosk prior to unlocking a door of the kiosk for a customer, to unlock the door of the kiosk for the customer once payment information (or other identifying information) has been collected, and to capture a post-transaction image of the one or more shelves within the kiosk after the door of the kiosk has been closed and locked, signaling the conclusion of the transaction, respectively.

In one example, the kiosk can includes: a locking mechanism interposed between a door of the kiosk and a casing of the kiosk; a door sensor; a display that displays pricing information for products contained within the kiosk; a payment collection module; a shelf arranged within the casing of the kiosk; a camera arranged over and configured to capture images of the shelf; (optionally a radio antenna and a radio frequency identification reader arranged within the kiosk and reading data from RFID tags arranged on products stocked in the kiosk;) a processor that records an initial inventory of products within the kiosk, authenticates a payment data received at the payment collection module, triggers the locking mechanism to unlock the door in response to authentication of the payment data, records a final inventory of products within the kiosk in response to closure of the door detected at the door sensor, and initiates a payment with the payment data for a difference between the initial inventory and the final inventory, such as described in U.S. patent application Ser. Nos. 14/201,369 and 14/209,688.

In one implementation, the kiosk includes a single camera (or other optical sensor) arranged and centered over each open shelf installed within the kiosk. In this implementation, the kiosk can also include a fisheye lens or other wide-angle lens coupled to each camera such that field of view of the camera can capture the full depth and breadth of a shelf and its contents arranged below the camera. For example, for a kiosk with four 16″-square shelves vertically stacked and offset by 10″, the kiosk can include four CCD or CMOS cameras, including one camera arranged over each of the shelf and including a fisheye lens providing a 30″-diameter field of view at 10″ from the camera. The kiosk and/or the transaction system can also calibrate images according to various machine vision techniques and can correct images for lens distortion, chromatic aberration, etc. Alternatively, the kiosk can include multiple (e.g., two) cameras arranged over each shelf, such as one camera arranged in each rear corner of the kiosk over and directed toward a shelf or a stereo camera centered over and directed downward toward a shelf below. In this alternative implementation, the kiosk, transaction system, or other service can stitch images captured at an instance in time by two or more cameras into a three-dimensional image of the corresponding shelf and its contents.

In one implementation, the kiosk initiates a new transaction in response to receipt of payment information from a customer, such as in response to collecting valid payment information from a credit card swept through a card reader integrated into the kiosk. In response to receipt of the payment information, the kiosk unlocks its door to enable the customer to retrieve products from open shelves of the kiosk. Once the customer closes the door, the kiosk triggers a camera (or each camera) within the kiosk to capture a post-transaction image of the corresponding shelf. However, if the kiosk is cooled or heated, breach and then closure of the door of the kiosk may cause condensation (e.g., “fog”) to collect on the lens of the camera, thereby reducing quality of the post-transaction image. As the environment within the kiosk equilibrates over time, moisture on the lens of the camera may dissipate. Therefore, the kiosk can repeatedly trigger the camera to capture a new post-transaction image after the door of the kiosk is closed in order to capture successively higher-quality images of the shelf; as each successive higher-quality post-transaction image is captured by the camera, the kiosk can discard (e.g., delete) the preceding post-transaction image. In one example, in Block S130, the kiosk can trigger the camera to capture a new post-transaction image every second until a new transaction is initiated at the kiosk, and the kiosk can save the last post-transaction image captured before the new transaction is initiated. In a similar example, the kiosk can trigger the camera to capture a new post-transaction image every five seconds for the longer of three minutes (or 10% longer than an average time for moisture to dissipate by 90% from the lens) or until a new transaction is initiated, and the kiosk can upload the final post-transaction image with other transaction data for the transaction to a remote server for handling and distribution by the transaction system. In yet another example, in Block S130, the kiosk can characterize a sharpness of each post-transaction image captured by the camera, trigger the camera to capture a new image every two seconds until a post-transaction image with a sharpness exceeding a threshold sharpness is recorded, and discard all but the final, high-sharpness post-transaction image for the transaction.

In the foregoing implementation, the kiosk can additionally or alternatively include: a heating element adjacent the lens of the camera; an anti-fog, hydrophobic, and/or hydrophilic coating or layer over the lens of the camera; a mechanized cover that intermittently isolates the camera lens from the environment within the kiosk; and/or a mechanical wiper that wipes fog off of the lens. The kiosk can also manipulate a lighting system within the kiosk to illuminate shelves of the kiosk during image capture.

To collect a pre-transaction image for the new transaction in Block S110, the transaction system can retrieve a final post-transaction image captured at the kiosk (for the same shelf) for a previous transaction immediately preceding a new transaction, as shown in FIG. 1. In particular, because the contents and distribution of products on a shelf of the kiosk are unlikely to change between closure of the door of the kiosk during a first transaction and opening of the door of the kiosk in a subsequent transaction, the post-transaction image of the first transaction can suffice as the pre-transaction image for the subsequent transaction. However, the kiosk can include a motion sensor (e.g., an accelerometer), can analyze outputs of the motion sensor between the first and subsequent transaction to determine if the kiosk has been substantially jostled (e.g., by an earthquake), and can trigger the camera to capture a new pre-transaction image upon initiation of the subsequent transaction and before the door of the kiosk is unlocked for a customer if the kiosk is determined to have been substantially moved or jostled between the first and the subsequent transactions. Alternatively, for each new transaction at the kiosk, the kiosk can trigger the camera (or a camera arranged over each shelf therein) to capture a pre-transaction image of the shelf once a new transaction at the kiosk is initiated and before the door of the kiosk is unlocked for the customer.

### 4. Remote Human Operator

Block S140 recites detecting a difference between the pre-transaction image and the post-transaction image; Block S150 recites, based on the difference, flagging a portion of the pre-transaction image for review by a remote human operator; and Block S160 recites, in response to receipt of confirmation of a product type corresponding to the difference from the remote human operator, billing the customer for a cost of the product type according to the payment information. Generally, the transaction system (or the kiosk) can execute Blocks S140, S150, and S160 of the method S100 build a transaction bucket and to bill a corresponding customer for a product(s) removed from the kiosk by the customer during a transaction. In particular, the transaction system can cooperate with the kiosk to retrieve a pre-transaction image of a shelf captured before the door of the kiosk was unlocked for a customer, to capture a post-transaction image of the shelf once the customer closes the door and the door is locked, and to distribute the pre- and post-transaction images to a remote human operator for identification of a change in inventory on the shelf and for identification a particular product removed from the kiosk during the transaction. The transaction system (or the kiosk) can then access payment information provided by the customer for the transaction and bill the customer for the cost of the identified product.

In one implementation, the kiosk packages a pre-transaction image and a post-transaction image for a transaction with related transaction data—such as a date and time of the transaction, a location and/or unique identifier of the kiosk, and payment information provided by the customer (e.g., a credit card number)—once the transaction is completed and upload this package to the transaction system (e.g., executing on a remote computer network or transaction server). The transaction system process the pre- and post-transaction images, as described below, and transmit relevant images and data to a remote human operator; the remote human operator then manually compares the pre- and post-transaction images, identifies a change (or no change) in contents on the corresponding shelf, and identifies a particular type of product removed from the shelf.

In this implementation, the transaction system can queue transaction data for review by the remote human operator substantially in real-time as the post-transaction image is uploaded from the kiosk. (The remote human operator can then review the image substantially in real-time or at her/his convenience.) Alternatively, the transaction system can batch transmission of transaction data to the remote human operator, such as by sending transaction images in sets (e.g., sets of ten) once a full set of (e.g., ten) sequential transaction are processed at the kiosk. Yet alternatively, the transaction system can send a batch of transaction data for all transactions occurring at the kiosk during a preset period of time (e.g., 24 hours) upon the conclusion of the time period.

The transaction system (or the kiosk) can assemble pre- and post-transaction images corresponding to each shelf within the kiosk into one job and queue this job to a single remote human operator. For example, for a kiosk with four shelves and one camera arranged over each shelf, the transaction system can transmit, to a single remote human operator, four pairs of pre- and post transaction images (or a target image, as described below) for a single transaction completed at the kiosk. Alternatively, the transaction system can distribute pre- and post-transaction images for one transaction at one kiosk to multiple distinct remote human operators for processing.

In a similar implementation, for a kiosk with multiple shelves, the transaction system compares the pre- and post-transaction images pair for each shelf of the kiosk for one transaction to identify one or more particular shelves of the kiosk that exhibited substantially no change in contents or content positions and then discards these substantially identical pre- and post-transaction image pairs or flags these image pairs for withholding from the remote human operator. For example, if the pre-transaction image for a particular shelf is substantially identical to the post-transaction image for the particular shelf for a particular transaction, the transaction system can discard both the pre- and post-transaction images for the particular shelf for the particular transaction and transmit to the remote human operator (or flag or queue for review by the remote human operator) only pre- and post-transaction image pairs—for other shelves of the kiosk—that differ for the particular transaction. The transaction system can thus collect and store pre- and post-transaction images for each shelf of each kiosk affiliated with the transaction system but only prompt the remote human operator to review pre- and post-transaction image pairs exhibiting substantial differences indicative of a change in inventory on the corresponding shelf, thereby reducing the number of image pairs that the remote human assistant must review and maintaining a high correlation between image pairs designated for review and removal of products from corresponding shelves of kiosks.

Furthermore, once a pre- and post-transaction image pair for a particular shelf in the kiosk for a particular transaction is uploaded from the kiosk to the transaction system, the transaction system can compare the pre-transaction image to the post-transaction image to identify specific regions of the two images that differ. The transaction system can then highlight these regions in the pre-transaction image (and in the post-transaction image) in order to provide additional guidance to the remote human operator reviewing the pre-transaction image, a portion of the pre-transaction image (the “target image”), and/or both the pre- and post-transaction images. For example, prior to transmitting the image pair to the remote human operator (or flagging the image pair for review by the remote human operator), the transaction system can lay a closed colored contour—such as a red circle or a lime-green rectangle of sufficient line weight to be visually distinct—over the regions of the pre-transaction image that differs from the post-transaction image. In another example, the transaction system an add a translucent colored overlay (e.g., a red circular region of 30% opacity) over the region of the pre-transaction image that is distinct from the post-transaction image and can add a similar translucent colored overlay over the region of the post-transaction image that is distinct from the pre-transaction image. In yet another example, the transaction system can crop the pre-transaction image to include only a region(s) distinct from the post-transaction image and can crop the post-transaction image to include only a region(s) distinct from the pre-transaction image

The transaction system (or the kiosk) can also reconcile actual inventory at the kiosk and inventory changes due to transactions at the kiosk—such as at end of each day or when the kiosk is restocked—to determine if a product was not detected or otherwise improperly counted in a transaction occurring at the kiosk since a previous reconciliation event. For example, when the kiosk is restocked or if a difference between actual inventory of a product on a shelf and a predicted inventory of the product on the shelf is determined based on manual or computer vision-based analysis of an image of the shelf, the transaction system can trigger a new reconciliation event. In this example, the transaction system can reprocess all pre- and post-transaction image pairs for transactions occurring between the new and a previous reconciliation event (a “reconciliation period”) to identify a particular transaction for which a product was miscounted (e.g., not counted or double-counted). The transaction system can then return any excess funds paid by a customer for product not actually purchased, and the transaction system can bill a customer for any undercounted product, only if the cost of undercounted products during the reconciliation period exceeds a threshold value (e.g., $25.00), or only if the estimated cost for a remote human operator to review the full series of image pairs for the kiosk during the reconciliation period is less than the recuperated value from billing customers for products not properly counted and billed for previously.

Alternatively, the kiosk can locally execute similar methods and techniques similar to those described above to flag image pairs exhibiting substantial differences—and therefore substantially likely to be correlated with removal of a product from the corresponding shelf of a kiosk—and can selectively upload such distinct image pairs to the transaction system for subsequent distribution to a remote human operator.

### 5. Operator Assistance

The transaction system can also assemble a database of guidance images for new products stocked in a kiosk to provide, to a remote human operator, improved guidance for identifying a product removed from the kiosk over time.

In one implementation, when a supplier adds a new product type to a menu for a kiosk, the supplier can upload the transaction system a stock digital image of the new product type. In this implementation, the transaction system can load the stock image into a digital menu for the kiosk, and the kiosk can render the digital menu—including the stock image of the new product—on a display arranged on the kiosk. The transaction system can also pass the stock image to a remote human operator for manual comparison to a target image from a subsequent transaction at the kiosk. However, in this implementation, the stock image of the product type may have been captured from a vantage point substantially different from the position of an overhead camera over a shelf on which units of the product type are placed, thereby yielding a relatively high degree of difficulty for the remote human operator to match a target image from a subsequent transaction with the stock image of the new product type. (This difference between the perspective from the stock image of the new product was captured and the position of an overhead camera over a shelf containing units of the new product can similarly limit the effectiveness of computer vision techniques in matching the stock image to a target image of a unit of the new product type captured by the overhead camera.) Therefore, the transaction system can create additional example images of a new product type from target images confirmed as exhibiting the new product type to provide improved guidance to a remote human operator over time, thereby improving remote human operator's speed and accuracy capacity for detecting the new product type.

In one example, for a first transaction at a kiosk after the kiosk was stocked with a new product type, the transaction system can transmit a stock image of the new product to an instance of an operator interface for a remote human operator assigned to the first transaction at the kiosk. In this example, if the remote human operator confirms that a (first) target image for the transaction indicates that a unit of the new product type was removed from the kiosk during the first transaction, the transaction system can store the first target image (and/or the corresponding pre-transaction image, such as with the sold unit of the new product highlighted or circled) and associate the first target image with the new product type. Subsequently, for a second transaction at the kiosk after the kiosk was stocked with the new product type, the transaction system can present both the stock image and the first target image from the first transaction to a remote human operator assigned to the second transaction. Furthermore, if the remote human operator confirms that a (second) target image for the transaction indicates that a unit of the new product type was removed from the kiosk during the second transaction, the transaction system can store the second target image and associate the second target image with the new product type. The transaction system can then repeat the foregoing for subsequent transactions at the kiosk until a database of target images for the new product type is of sufficient size to obviate the stock image of the new product type.

When a remote human operator reviews a new pre- and post-transaction image pair (or merely a target image) for a recent transaction through an instance of the operator interface, the transaction system can generate a prioritized list of possible product types that may correspond to a unit removed from the kiosk during the corresponding transaction. For example, the transaction system can rank a first product type, a second product type, and a third product type, etc. in inventory in the kiosk at the time of the recent transaction based on: likelihood that the target image depicts the corresponding product type; trends in product sales from previous transactions; changes in RFID-based inventory (as described below); historical data regarding types of product historically placed on the corresponding shelf of the kiosk; the known size and/or shape of products stocked in the kiosk and similar relative sizes and shapes of objects in the image; historic purchase data of a customer for the transaction associated with the image; and/or historical sell time data for products stocked in the kiosk; etc. The interface can then render: a last target image associated (e.g., tagged) with the first product type and captured at the kiosk; a last target image associated with the second product type and captured at the kiosk; and a last target image associated with the third product type and captured at the kiosk in order of the ranking assigned by the transaction system. In this example, the remote human operator can then select the last target image associated with the second product type to view additional target images associated with the second product type. In particular, in response to selection of the target image for the second product type, the transaction system can serve the most recent ten target images associated with the second product type to the user interface for presentation to the remote human operator. However, if fewer than ten target images for the second product type are currently available, the transaction system (or the operator interface) can serve a stock image and all target images currently available for the second product type to the remote human operator.

Additionally or alternatively, when a supplier adds a new product to the kiosk, the kiosk can guide the supplier through a new product onboarding process. For example, the kiosk can prompt the supplier to place a unit of the new product within view of the camera and to enter product information into a user interface on the kiosk. The kiosk can then trigger the camera to capture an image of the unit of the product, and the transaction system can store this image as the stock image for the new product. The kiosk can also prompt the supplier to move the unit of the product though various positions and then capture images of the unit in the various positions, and the transaction system can collect these images and later serve them to a remote human operator to assist identification of like products.

The transaction system can also transmit or otherwise provide additional transaction data to the remote human operator through the operator interface with the remote human operator manually processes pre- and post-transaction image pairs. For example, the transaction system can push an updated inventory list, an initial list of inventory products for a current stocking period (e.g., product types and counts stocked in the kiosk during a most recent restocking event), and/or a static list of product types regularly stocked in the kiosk to a remote human operator. The transaction system can also prioritize inventory data sent to or shared with the remote human operator for a particular transaction to provide information most likely to be relevant to the operator first.

In one implementation, the transaction system extracts historical trends in product types (e.g., SKU numbers) placed on shelves of kiosks over time and provides a form of these historic trend data for a particular shelf to a remote human operator when reviewing a target image of the same shelf. For example, the transaction system can extract a frequency of product types placed on a particular shelf of a particular kiosk: from product stocking data of a supplier assigned to stock the particular kiosk; from historic RFID data (described below) of products removed from the particular shelf of the particular kiosk; and/or from historic data of product types previously identified in pre- and post-transaction images of the particular shelf of the particular kiosk. In this example, the transaction system can then generate a prioritized list of product types likely to be placed on a particular shelf of the kiosk based on frequencies of product types previously placed on the particular shelf. The transaction system can also limit historic data to a preset period of time (e.g., four weeks) when generating this prioritized list of product types for the particular shelf of a particular kiosk or apply greater weight to more recent stocking events for the product type on a particular shelf of the kiosk. In a similar example, the transaction system can identify a trend in location (i.e., position) of units of a particular product type placed on a particular shelf of a particular kiosk, and the transaction system can then correlate the position of a target region of a pre-transaction image of the particular shelf of the particular kiosk with the particular product type—with some calculated degree of confidence—based on the trend in location of units of the particular product type stocked on the particular shelf.

The transaction system can therefore serve: inventory data; prioritized or ranked lists of product types likely to be associated with a new target image (or pre- and post-transaction image pair) by the remote human operator for a new or recent transaction; SKU numbers; product type or product descriptions; or any other relevant transaction information to an instance of an operator interface for presentation to an assigned remote human operator. The remote human operator can thus review these transaction data alongside a target image (or the pre- and post-transaction image pair) when identifying a unit of one or more product types removed from the kiosk during a corresponding transaction.

When reviewing a target image (or a pre- and/or post-transaction image pair) within an instance of the operator interface, the remote human operator can select an image, description, or SKU number, etc. or select or enter any other suitable image, text, or information within the interface to confirm a product type for a transaction under review, as shown in FIG. 1. As described above, the transaction system can then retrieve the product type confirmation from the remote human operator, access a cost of a unit of the product type (e.g., from a static or dynamic price list assigned to the kiosk or to a region in which the kiosk is located), and bill the corresponding customer accordingly. Furthermore, for transactions in which multiple products were removed from the kiosk, the transaction system can aggregate multiple confirmations for product types identified as removed from the kiosk during the same transaction, access cost data for each corresponding product type, aggregate these product costs, and bill the customer accordingly.

In another implementation in which a camera is installed at a fixed distance from an adjacent shelf, the kiosk and the transaction system can estimate a number of units of a product stacked on the shelf based on a size of a region of an image corresponding to a unit of the product. In particular, the transaction system can apply known product data (e.g., including known dimensional of products, known sizes fiducials or text applied to product packaging, etc.) to the image to map the size of a product in an image to a real distance of the product to the camera and thus a number of units of the product stacked on the shelf and a number of units blocked from the camera's view. The transaction system thus can share pre- and post-transaction product stacking data with a remote human operator to further assist a remote human operator in identifying one or more products removed from the kiosk during the corresponding transaction.

The kiosk can also include a scale or other weight sensor coupled to a shelf contained therein, and the transaction system can share pre- and post-transaction shelf weight data with a remote human operator to provide additional guidance to the remote human operator.

### 6. Machine Learning

The transaction system can also build a training set of template images of one or more product types manually confirmed in pre- and/or post-transaction images by remote human operators for transactions as one or more kiosks; the transaction system can thus apply computer vision techniques—in conjunction with this training set—to automatically identify products removed from the kiosk based on to pre- and/or post-transaction images (or target images) captured during subsequent transactions at the kiosk.

In one implementation, once a product removed from a shelf of a kiosk is identified from a pre- and post-transaction image pair by a remote human operator, the transaction system stores the region of the pre-transaction image corresponding to the removed product (the target image) as a template image in a training set for the identified product type, as shown in FIG. 1. The transaction system continues to augment the training set for the product type with target images from subsequent transactions in which the same product type is confirmed by a remote human operator. The transaction system can tag these template images with the corresponding a product type to build a computer vision training set specific to the kiosk, or the transaction system can add these target images to a computer vision training set specific to the corresponding product type. Furthermore, the transaction system can apply a training set of target images (i.e., template images) to a single shelf within a kiosk, to all shelves within a kiosk, or to all or a subset of kiosks within a region or stocked by the same supplier.

Once a training set for a particular product type grows to a sufficient size to yield a sufficient confidence in the accuracy of computer vision techniques to detect the product type in pre- and/or post-transaction images, the transaction system can execute computer vision techniques to compare the target image from a transaction to template images of known products types stocked in the kiosk to automatically (i.e., without a remote human operator) identify a product type for the transaction. For example, if a template image (e.g., a target image in a training set) associated with a known product type is matched to the target image of a recent transaction with at least a threshold confidence (e.g., at least 98%), the transaction system can access a price for the product type and bill the customer for purchase of the product accordingly. However, in this example, if a no template image in an available training set for any product is matched to the target image from a recent transaction or if a template image in the training set is matched to the target image but with less than the threshold confidence, the transaction system can flag the pre- and post-transaction image pair for review by a remote human operator.

### 7. Fiducials

In one variation, optical fiducials are arranged within on shelves and/or on products within a kiosk, and the transaction system (or the kiosk) identifies fiducials within images of shelves to identify products, to identify changes in product inventory on shelves, and/or to provide additional guidance to a remote human operator.

In one implementation, a cartridge (or tray, etc.) configured to contain multiple units of the same product type is installed on a shelf of the kiosk within the field of view of a camera arranged over the shelf. An optical fiducial—such as a round orange sticker or a sticker exhibiting a Quick Response (QR) code—is installed, adhered, printed, or otherwise applied to a surface of the cartridge facing the overhead camera. The fiducial can be associated (e.g., in local memory at the kiosk or in a database hosted by the transaction system) with a particular cartridge type configured to dispense a particular product type, and the transaction system can implement machine vision techniques to identify the fiducial in a particular region of a pre-transaction image (or a post transaction image) for a transaction at the kiosk and can thus correlate the particular region of the pre-transaction image with the particular cartridge type product—and therefore the particular product type—based on the identified fiducial. Furthermore, if the particular region of the pre-transaction image differs from the corresponding region of the post-transaction image for the transaction, the transaction system can determine that one or more units of the product type dispensed from the particular cartridge type was removed from the kiosk during the transaction. The transaction system can then flag the pre- and post-transaction images—with a note specifying the identified product type—for review by the remote human operator, as described above, for a count of units of the product type that were removed from the kiosk during the transaction. Alternatively, once the transaction system thus confirms a product type removed from the kiosk during the transaction, the transaction system can then apply template images of the product type to the target region (of the pre-transaction image) for the transaction to count a number of units of the product type removed from the kiosk during the transaction.

Additionally or alternatively, a cartridge installed in a kiosk can include a fiducial arranged in or over receptacle position configured to accept a (single) unit of the product type, and the transaction system can identify such fiducials visible in the pre- and post-transaction images for a transaction, count a difference in the number of visible fiducials between the pre-transaction image and the post-transaction image, and access a database of fiducials to thus identify a product type associated with fiducials in the pre- and post transaction images and to confirm a number of units of the product type removed from the kiosk during the transaction.

Similarly, a kiosk supplier can apply fiducials (e.g., colored stickers or QR stickers) directly onto product packaging of units of a product type, and the transaction system can initially detect fiducials in both pre- and/or post-transaction images of a transaction and identify a decrease in detect fiducials from the pre-transaction image to the post-transaction image to determine that the corresponding product type was removed from the kiosk during the transaction. For example, the transaction system can access a fiducial database to identify a product type associated within fiducial identified in a pre- and/or post-transaction image. As described above, the transaction system can also store the target region from the pre-transaction image as a template image for the product type with other target images from previous transactions in order to build a training set of templates images of the product type.

A kiosk supplier or a kiosk operator can thus apply a fiducial to a cartridge installed in the kiosk, and the transaction system (or kiosk) can identify the fiducial in images of the cartridge captured with the overhead camera(s) to build a set of template images (or a ‘training set’) of the corresponding product type. Once the training set is of sufficient size to identify units of the product type in target images from the kiosk with at least a threshold confidence, the transaction system can prompt the kiosk supplier to cease application of fiducials onto cartridges and/or onto units of the product type stocked in the kiosk.

### 8. RFID

In one variation, the kiosk includes a radio antenna and an RFID that cooperate to scan RFID tags arranged on products stocked on a shelf of the kiosk. In this variation, the kiosk is stocked with products labeled with RFID tags, and the kiosk identifies products removed therefrom during a transaction by comparing a list of RFID serials received before the transaction and received after a transaction, such as described in U.S. patent application Ser. Nos. 14/201,369 and 14/209,688. However, in this variation, the kiosk (or the transaction system) can fuse RFID inventory change data from a transaction with pre- and post-transactions images for the transaction to supervise generation of a training set of template images of one or more product types stocked in the kiosk over time.

In one implementation, the transaction system (or the kiosk) passes a RFID serial number—corresponding to a change in inventory at the kiosk over a transaction—into a domain name system (DNS) or other database to retrieve identifying information (e.g., a product type, a supplier, a SKU number, etc.) of a product on which the corresponding RFID tag was installed. During the transaction, the kiosk also captured pre- and post-transaction images of the shelf of the kiosk from which the product was removed, and the transaction system stores the target image (e.g., the disjoint of the pre- and post-post transaction images) from the transaction as a template image for the product type identified from the RFID serial number. Furthermore, once a training set of template images thus constructed yields a sufficiently high accuracy rate (e.g., greater than 98%) of identification of the product type in images captured at the kiosk through a purely computer vision solution, the transaction system (or the kiosk) can notify a supplier for the product type that RFID tags for the product type are no longer needed for the kiosk. For example, the transaction system and the kiosk can therefore merge RFID data and transaction images to automatically build a computer vision training set for a particular product type over time and can then prompt a supplier of the product type to stop labeling products with RFID tags once the computer vision training set yields false positives and false negatives in less than a threshold percentage of transactions at the kiosk, thereby eliminating use of RFID tags for the product type and reducing restocking costs at the kiosk. Similarly, the kiosk can selectively distribute images to a remote human operator for matching to one or more products when a corresponding RFID inventory test returns a confidence score below a threshold confidence score. However, the kiosk can still support transactions with one-off, low-production, custom, or seasonal products by identifying these product based on RFID data collected from RFID tags arranged on units of these product types but can implement computer vision techniques to handle transactions with more standard products, thereby reducing support cost for these more standard products stocked in the kiosk.

In this variation, once the door of the kiosk is closed near the end of a transaction, the kiosk can first sample the RFID reader to collect RFID data from RFID tags arranged on products (or on shelves) within the kiosk, disable the RFID antenna and reader once the RFID data is collected, and can then capture images of shelves of the kiosk with corresponding cameras in order to reduce electromagnetic interference between the RFID antenna and reader and the camera(s). For example, once door of a kiosk closes, the kiosk can power the RFID antenna and sample the RFID reader for a period of five seconds and then power down the RFID antenna and reader before sampling the camera(s), as described above. Alternatively, the kiosk can include electromagnetic shielding around the camera to enable substantially simultaneous operation of the camera and the RFID reader.

### 9. Customer Feedback

In one variation of the method S100, the transaction system compares pre- and post-transaction images to identify products that a customer touched or moved but did not finally remove from the kiosk during a transaction. In this variation, the transaction system can also prompt a customer to provide feedback regarding why a product was not finally selected in a transaction if pre- and post-transaction images for the transaction indicate that the product was touched or moved by the customer but not removed from the kiosk.

In one implementation, the transaction system implements computer vision techniques—as described above—to both determine what products a customer removed from a shelf of the kiosk and to determine what products the customer merely moved on the shelf of the kiosk based on a comparison of a pre-transaction image and a post-transaction image for the transaction. In one example, the transaction system: implements edge detection techniques to identify product boundaries in both the pre- and post-transaction images for the a transaction; interpolates real linear and angular displacements of products on the shelf based on differences in positions of product boundaries of similar coloring and shapes in the pre- and post-transaction images; correlates small linear displacement (e.g., <0.25″) and/or angular displacements (e.g., <2°) of a product boundary with incidental contact with the product by a customer; and correlates larger linear displacements (e.g., >0.25″) and/or angular displacements (e.g., >2°) of a product boundary with intentional contact with (e.g., removal and then replacement of) the corresponding product by the customer.

In the foregoing implementation, for a product boundary in a pre- (or post-) transaction image correlated with intentional displacement by a customer, the transaction system can queue the pre-transaction image for review by a remote human operator to identify the product type (or a specific serial number) of the displaced product. Alternatively, the transaction system can implement computer vision techniques, as described above, to automatically identify a type of the displaced product.

Subsequently, if the transaction system determines that a customer selected a product from the shelf of the kiosk but returned the product to the shelf before completing the transaction, the transaction system can prompt the customer to provide feedback regarding why the product was not purchased. For example, the transaction system can push a notification to a smartphone associated with the customer with a prompt to complete a survey regarding the customer's recent transaction at the kiosk, including why the customer did not purchase the product. In this example, the transaction can generate a survey identifying a type of the product not purchased and containing a prepopulated list of reasons the product was not purchased, such as including: “I just moved the unit to get to another product;” “It looked spoiled;” “I changed by mind once I saw the ingredient list” with a fillable form to identify the averted ingredient; “Felt like too much food once I picked it up;” and “Felt like too little food once I picked it up.” Furthermore, if the customer indicates through the survey that the product is spoiled, the transaction system can prompt a kiosk operator to remove the product or can incentivize the customer to go back to the kiosk to remove and discard the product in exchange for a discard fee paid to the customer. In this example, the transaction system can also prompt a remote human operator to look for spoilage of a product in an image of a corresponding shelf of the kiosk based on the customer's suggestion that product in the kiosk has spoiled.

In this variation, the transaction system can also update thresholds for predicting whether a customer moved a product in order to reach another product or intentionally removed and returned a product based on frequencies of “just moved to get to another product” customer responses and corresponding linear and angular disturbance of corresponding products during transactions at the kiosk over time. The transaction system can also prompt a supplier to modify or remove an ingredient in a particular product type based on a frequency of customer responses regarding the ingredient in the product type. Similar, the transaction system can prompt a supplier to modify a stock size of a product type or to provide an additional, alternative size for the product type based on such feedback from customers. However, the transaction system can collect and process customer feedback data in any other suitable way.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for processing transactions at a vending kiosk comprising:
at a first time, capturing a pre-transaction image of a shelf arranged within the kiosk with an optical sensor;
in response to receiving payment information from a customer, unlocking a door of the kiosk;
at a second time succeeding the first time, capturing a post-transaction image of the shelf with the optical sensor in response to closure of the door;
detecting a difference between the pre-transaction image and the post-transaction image;
based on the difference, flagging a portion of the pre-transaction image for review by a remote human operator; and
in response to identification of a product type corresponding to the difference by the remote human operator, billing the customer for a cost of the product type according to the payment information.
